(19) United States
(12) Patent Application Publication
(10) Pub. No.: US 2014/0189847 A1
(43) Pub. Date: Jul. 3, 2014

(54) REMOTE VPN PROVISIONING OF AN ENDPOINT

(71) Applicant: AASTRA TECHNOLOGIES LIMITED, Concord (CA)

(72) Inventors: Francis SHEN, Concord (CA); Paulo FRANCISCO, Concord (CA)

(73) Assignee: AASTRA TECHNOLOGIES LIMITED, Concord (CA)

(21) Appl. No.: 14/143,409

(22) Filed: Dec. 30, 2013

Related U.S. Application Data
(60) Provisional application No. 61/747,702, filed on Dec. 31, 2012.

(51) Int. Cl. H04L 29/06

(52) U.S. Cl. CPC H04L 63/0272
USPC 726/15

(57) ABSTRACT

A method for remote deployment of at least one terminal device in a virtual private network (VPN), the method comprising the steps of instructing the terminal device to use a VPN connection for connectivity and media communication; at the call manager server, generating a certificate for the VPN connection; providing the terminal device with the certificate and instructing the terminal device to restart; and negotiating the VPN connection with the call manager server to establish the VPN connection.

### CROSS-REFERENCE TO RELATED APPLICATIONS

This application claims the benefit of priority to U.S. Provisional Application Ser. No. 61/747,702 filed on Dec. 31, 2012.

### FIELD OF THE INVENTION

The present invention relates to packet switched networks, and more particularly to provisioning an endpoint for communication in a virtual private network (VPN).

### DESCRIPTION OF THE RELATED ART

VPN services have gained in popularity as an increasingly mobile and disparate work force needs reliable, low-cost remote connectivity to business applications and resources. A VPN is generally a private network that uses a public network (usually the Internet) to connect remote sites or users together. Instead of using a dedicated, real-world connection such as a leased line, a VPN uses “virtual” connections routed through the Internet from the company's private network to the remote site or employee. However, setting up a remote VPN client is a problem because remote connectivity cannot be established, and the purpose of the VPN connection is to establish that connectivity. Generally, a typical remote site client operates within a private network, such as a home network, and is protected by both a firewall and Network Address Translator (NAT). To the outside world, this client is not reachable as the public IP address can change dynamically and the firewall will block any external requests. This makes it very difficult for a centralized system administrator to setup, customize and activate a newly deployed remote terminal device. In addition, deployment over public networks, such as the Internet, is often impeded by lack of interoperability and complexity of configurations.

It is an object of the present invention to mitigate or obviate at least one of the above-mentioned disadvantages.

### SUMMARY OF THE INVENTION

In one of its aspects, there is provided a method for remote deployment of at least one terminal device in a virtual private network (VPN), the method comprising the steps of:

providing at least one terminal device with client software from a call manager;

updating said at least one terminal device with said terminal settings as defined by said call manager server;

instructing said at least one terminal device to use a VPN connection for connectivity and media communication;

at said call manager server, generating a certificate for said VPN connection;

providing said at least one terminal device with said certificate;

instructing said at least one terminal device to restart;

causing said client software to enable VPN connections and negotiate said VPN connection with said at least one call manager server;

establishing said VPN connection; and

presenting a login page on a graphical user interface associated with said terminal device.

In another of its aspects, there is provided a call manager server, the call manager server comprising:

a machine-readable medium having embodied thereon a computer program coded to provide instructions for provisioning at least one terminal device for communication in a VPN, said computer program coded to:

periodically provide said at least one terminal device with client software updates and terminal settings configuration data;

cause said at least one terminal device to use a VPN connection for connectivity and media communication;

generate a certificate for said VPN connection;

forward said certificate to said at least one terminal device;

instruct said terminal device to restart following receipt of said certificate;

negotiate said VPN connection with said at least one terminal device;

establish said VPN connection upon successful negotiation; and

present a login page on a graphical user interface associated with said at least one terminal device.

In yet another aspect, there is provided a terminal device comprising:

a machine-readable medium having embodied thereon a computer program coded to provide instructions for provisioning said terminal device for communication in a VPN, said computer program coded to:

cause said terminal device to establish a VPN connection for connectivity and media communication;

request a certificate for said VPN connection; and receive;

cause said terminal device to restart following receipt of said certificate;

negotiate said VPN connection with a host device; and

establish said VPN connection upon successful negotiation.

Advantageously, by facilitating substantially hassle-free installations or configuration of IP endpoints for end-users, the operational burden of service activation, requests for support for installation or technical assistance are substantially diminished or eliminated. Consequently, service providers are presented with a competitive time-to market and a service cost advantage. Additionally, service providers have the freedom to choose any number of IP endpoints from numerous manufacturers without being concerned about the resources normally required to provision the IP endpoints using prior art methods.

### BRIEF DESCRIPTION OF THE DRAWINGS

Several preferred embodiments of the present invention will now be described, by way of example only, with reference to the appended drawings in which:

FIG. 1 shows a schematic diagram of a system for provisioning a terminal device for communication in a VPN, in a preferred embodiment; and

FIG. 2 is a flowchart outlining exemplary steps in a method for provisioning a terminal device for communication in a VPN.

### DETAILED DESCRIPTION OF EXEMPLARY EMBODIMENTS

The detailed description of exemplary embodiments of the invention herein makes reference to the accompanying block diagrams and schematic diagrams, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present invention may also be described herein in terms of screen shots and flowcharts, optional selections and various processing steps. The present invention may employ various integrated circuit components (e.g., memory elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERL, extensible markup language (XML), smart card technologies with the various algorithms being implemented with any combination of data structures, objects, processes, routines or other programming elements. Further, it should be noted that the present invention may employ any number of conventional techniques for data transmission, signaling, data processing, network control, and the like.

As is known in the art, Internet Protocol (IP) is a routing protocol designed to route traffic within a network or between networks. IP is described in IETF RFC-791, incorporated herein by reference. However, the present invention is not limited to IP data interfaces and other data interfaces can also be used.

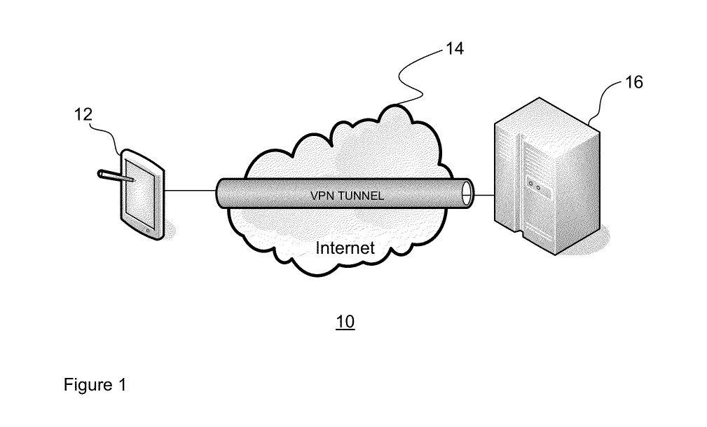

FIG. 1 illustrates a system 10 for provisioning a network entity 12 for communication in a virtual private network (VPN), with minimal end-user intervention. The network entity 12 may be any IP device or endpoint (end node) for participating in a packet switched network, such as, but not limited to, IP phones, H.323 phones, DECT phones, SIP-DECT phones, videophones, ATAs, mobile phones, IPTVs, projectors, PDAs, digital cameras, PC, MP3 players, set-top boxes, game consoles, gateways, soft phones, firewalls, access-points, modems, network appliances, or any combination(s) thereof. These exemplary network entities 12 include a data processing means comprising a processor (which may be referred to as a central processor unit or CPU, logic means, or controller) that is in communication with a machine-readable medium (computer-readable medium), input/output (I/O) devices, a network interface, and other interfaces. A computer-readable medium is any physical object that can store information in a form directly readable by a computer. Thus, magnetic, optical, and electrical storage devices are all contemplated, as well as any other method of storing information directly accessible to a computer. Hard disks, floppy disks, CD/DVD ROM drives, RAM chips, magnetic tapes, barcodes, punch cards, and the like are all examples of computer-readable media. The network entity 12 may be a terminal device which generally includes a client application which encrypts and encapsulates data into VPN secured packets and re-addresses the packets.

First, the terminal device 12 is communicatively coupled to a network 14, such as a public network or the Internet, following manual configuration or an automated configuration process using auto-discovery mechanisms. As an example, the terminal device 12 obtains an IP address provided through a Dynamic Host Configuration Protocol (“DHCP”) server. Alternatively, the terminal device 12 may be preconfigured with an assigned static IP address. The computer-readable medium of the terminal device 12 is included with factory-set default data, such as, a URI to a call manager server 16 to route calls and process signaling, or an address of an intranet server to establish a VPN connection with, and a port number of a port on the local loopback interface to which traffic is forwarded. The call manager server 16 may also include a repository of the configuration data, digital certificates for the terminal device 12, or is coupled to configuration servers having that configuration data. The URI of the call manager server 16 may be a public name or IP address, for example, “blustarserver.aastra.com”; however, the URI may be customized as part of the branding for a partner/customer in an OEM agreement. The call manager server 16 is preferably remotely based and includes data processing means comprising a processor (which may be referred to as a central processor unit or CPU, logic means, or controller) that is in communication with a computer-readable medium having data and/or program code, input/output (I/O) devices, a network interface, and other interfaces. Preferably, the call manager server 16 is scalable, robust and includes failover capabilities and built-in redundancies.

Next, the remote device 12 initiates a connection destined to the call manager server 16, the connection request is received by a firewall but is not considered a threat, as such a connection request is similar or equivalent to a user starting a browser session. The connection request includes a unique identifier associated with the terminal device, such as a media access control (MAC) address. Preferably, the terminal device 12 connects over port 443 (HTTPS) to the call manager server 16 IP address, such that the connection is encrypted and secure. The call manager server 16 then acknowledges the connection request from the remote device 12, determines the remote device 12's public IP address thus gaining the necessary route back information for communications. Since communication is initiated by the remote terminal device 12, the firewall permits the call manager server 16 to send unsolicited traffic provided that the remote terminal device 12 keeps the communication channel active. Maintaining the communication channel active is achieved by causing the remote terminal device 12 to periodically “poll” the call manager server 16 for software updates, such as the client application and other information.

Upon initiating the above contact, and establishing a bi-directional communication link, the call manager server 16 detects the terminal device 12 type, the terminal device 12 state and performs a series of maintenance and update activities as provisioned by the system administrator. These activities may be customized for each terminal device 12 as each terminal device 12 is uniquely identified by its MAC address.

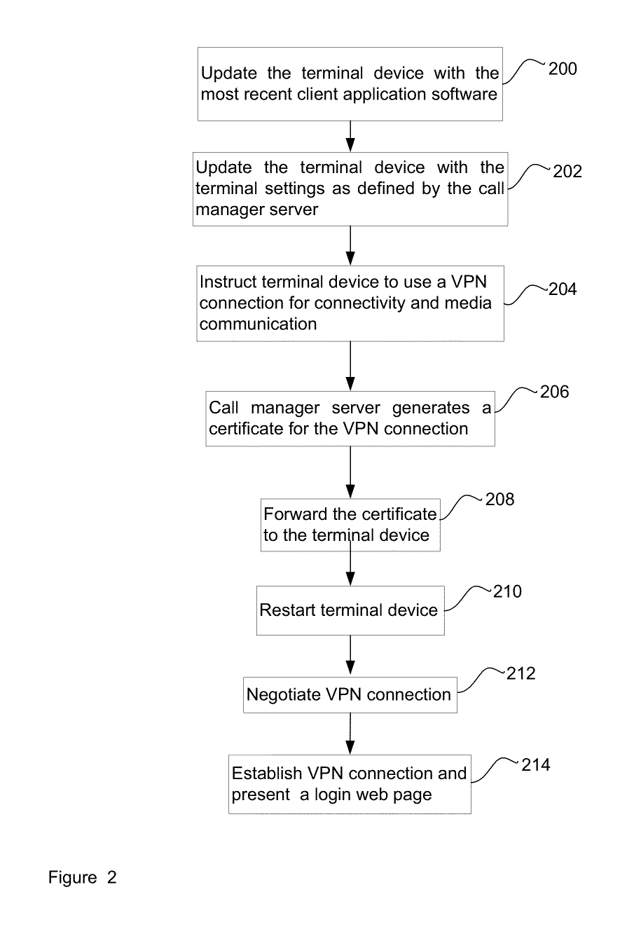

As shown in FIG. 2, an exemplary method for VPN provisioning of a remote terminal device 12 comprises the exemplary steps of: updating the terminal device 12 with the most recent client application software as defined by the call manager server 16 (step 200); updating the terminal device 12 with the terminal settings as defined by the call manager server 16 (step 202). These settings range in function and comprise such capabilities as definition of global address directories, screen saver timeouts, initial video and audio rates, among others. Next the terminal device 12 is instructed to use a VPN connection for connectivity and media communication (step 204). The call manager server 16 then generates a certificate for the VPN connection (step 206), and forwards the certificate to the terminal device 12. Alternatively, the call manager server 16 provides the generated certificate to another server, and informs the terminal device 12 of the location (IP address, URI) of that other server in order to retrieve the certificate therefrom (208). Next, the call manager server 16 instructs the terminal device 12 to restart (step 210). Upon restarting, the client application is launched and the remote terminal device 12 is now enabled for VPN communications, for example, a local setting associated with the VPN is now set to “VPN enable”, and so the terminal device 12 calls out to the call manager server 16 and negotiates the VPN connection (step 212) or negotiates the encryption methodologies and algorithms for use to secure the VPN connection, establishes the connection and presents the user with a login web page (step 214). The login web page is presented to the user via the web browser of the terminal device 12. In the event that VPN connection fails or takes longer than expected to be established, the remote terminal device 12 presents the end user with a warning stating that the connection is not yet established. This prevents the user from attempting to login until the VPN process is successfully completed.

Advantageously, these provisioning steps obviate the need for an end user to have to read and follow instructions on how to setup VPN. Further, these steps greatly minimizes the preparation time, by the system operator, prior to deployment of the terminal device 12. Typically, the system administrator would have to invest a substantial amount of time to un-package and set up a terminal device 12, verify proper function of the terminal device 12, and finally re-package and ship the terminal device 12. Since the terminal device 12 is to be used in a private network, this setup would need to be done on a private IP cloud further complicating the staging setup. Alternatively, the user would have to contact a technical support person who would then have to instruct the user on how to navigate several menus and setup the terminal device 12.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description is presented for purposes of illustration only and not of limitation, and the scope of the invention is defined by the preceding description, and with respect to the attached claims.

The embodiments of the invention in which an exclusive property or privilege is claimed are defined as follows:

1. A method for remote deployment of at least one terminal device in a virtual private network (VPN), the method comprising the steps of:
providing said at least one terminal device with client software;
updating said at least one terminal device with said terminal settings
instructing said at least one terminal device to establish a VPN connection for connectivity and media communication;
providing a certificate for said VPN connection to said at least one terminal device;
instructing said at least one terminal device to restart following said updating;
causing said client software to negotiate said VPN connection and establish said VPN connection; and
presenting a login page on a graphical user interface associated with said terminal device.

2. The method of claim 1, wherein said client software initiates communication with a call manager server using a uniform resource identifier (URI) associated with said call manager server.

4. The method of claim 2, wherein said terminal settings are defined by said call manager server.

5. The method of claim 4, wherein said at least one terminal device is assigned a unique identifier, and said settings comprise configuration parameters associated with said unique identifier.

6. The method of claim 5, wherein said settings comprise configuration parameters.

7. The method of claim 6, wherein said call manager server generates said certificate.

8. The method of claim 7, wherein said VPN connection is established between said call manager.

9. The method of claim 8, wherein said unique identifier is a media access control (MAC) address, and said VPN connection is established via port 443 using HTTPS protocol.

10. A call manager server comprising:
a machine-readable medium having embodied thereon a computer program coded to provide instructions for provisioning at least one terminal device for communication in a VPN, said computer program coded to:
cause said at least one terminal device to use a VPN connection for connectivity and media communication;
generate a certificate for said VPN connection;
forward said certificate to said at least one terminal device;
instruct said terminal device to restart following receipt of said certificate;
negotiate said VPN connection with said at least one terminal device; and
establish said VPN connection upon successful negotiation.

11. The call manager server of claim 10, wherein said at least one terminal device comprises client software, and wherein said client software is updates periodically by said call manager server.

12. The call manager server of claim 11, wherein said at least one terminal device is assigned a unique identifier, and said call manager server comprises configuration parameters associated with said unique identifier.

13. The call manager server of claim 12, wherein a login page is presented on a graphical user interface associated with said at least one terminal device.

14. A terminal device comprising:
a machine-readable medium having embodied thereon a computer program coded to provide instructions for provisioning said terminal device for communication in a VPN, said computer program coded to:
cause said terminal device to establish a VPN connection for connectivity and media communication;
request a certificate for said VPN connection; and receive;
cause said terminal device to restart following receipt of said certificate;
negotiate said VPN connection with a host device; and
establish said VPN connection upon successful negotiation.

15. The terminal device of claim 14, wherein said machine-readable medium comprises a URI of said host device.

16. The terminal device of claim 15, wherein said terminal device is associated with a unique identifier, and said unique identifier being associated with configuration parameters specific to said terminal device.

17. The terminal device of claim 16, wherein said host device provides computer program updates to said terminal device corresponding to said unique identifier.

18. The terminal device of claim 17, wherein said computer program is coded to present a login page on a graphical user interface associated with said terminal device.

19. The terminal device of claim 18, wherein said computer program is coded to present a login page on a graphical user interface associated with said terminal device.

20. The terminal device of claim 18, wherein said terminal device periodically polls said host device for updates.
